(19) United States
(12) Patent Application Publication
(10) Pub. No.: US 2024/0353551 A1
(43) Pub. Date: Oct. 24, 2024

(54) WIDE FIELD OF VIEW RADAR MODULE FOR THREE-DIMENSIONAL SENSING

(71) Applicant: ATCODI CO., LTD, Seoul (KR)

(72) Inventor: Jeong pyo KIM, Suwon-si (KR)

(21) Appl. No.: 18/685,829

(22) PCT Filed: Nov. 23, 2021
(86) PCT No.: PCT/KR2021/017253

§ 371 Date: Feb. 22, 2024

(30) Foreign Application Priority Data
Oct. 12, 2021 (KR) 10-2021-0135190

(51) Int. Cl. G01S 13/42; G01S 7/03; G01S 13/931

(52) U.S. Cl. CPC G01S 13/426; G01S 7/032; G01S 13/931

(57) ABSTRACT

Disclosed is A wide FoV radar module for three-dimensional detection according to an embodiment of the present invention. According to the present invention, at least one of the plurality of transmission channel units includes a 1-1st transmission channel antenna arranged in the first direction, thereby being responsible for detecting the short/mid/long distance horizontal directions and the detection of the mid/long distance elevation angle directions, By including a 1-2nd transmission channel antenna arranged in a second direction different from the first direction, it is responsible for detection of the short-distance horizontal direction and detection of the short-distance elevation angle direction, and detects the horizontal direction compared to the prior art through a single radar module. In addition to performance, the detection performance in the elevation angle direction is improved, which has the effect of minimizing the number of mounting units.

### TECHNICAL FIELD

The present invention relates to a wide of field of view (FoV) radar module for three-dimensional detection. More specifically, it relates to a wide FoV radar module for three-dimensional detection that has improved the detection performance in the direction of elevation angle for three-dimensional detection.

### BACKGROUND ART

An autonomous vehicle means a vehicle that can self-drive without a driver's direct manipulation, and research and development are actively underway to realize level 5 autonomous driving that enables complete autonomous driving.

In such autonomous vehicle, various sensors mounted on the vehicle play a large role in enabling autonomous driving in which an ECU of the vehicle controls various components within the vehicle based on data sensed by the sensors, thereby enabling autonomous driving.

Meanwhile, as a representative example of sensors enabling autonomous driving, there is a radar. This radar is a device that transmits strong electromagnetic waves to a specific object, receives echo waves reflected back from the object and having the same polarization characteristics as those of the transmitted electromagnetic waves and detects the location, moving speed and the like of the object using the echo waves. As radars for autonomous vehicles, there exist a long range radar (LRR) for detecting a long distance, a middle range radar (MRR) for detecting a middle distance, a short range radar (SRR) for detecting a short distance and the like, depending on the driving conditions of the vehicle.

In conventional arts of radars for autonomous vehicles, priority was given to including the widest range as the detection area through one-time sensing. This is called the wide FoV characteristic of the radar. As illustratively shown in FIG. 1 as the radiation pattern, efforts were made to implement the widest azimuth angle (α) in the horizontal direction parallel to the road, and it was enabled by arranging the antennas included in the radar in the vertical direction.

However, since such conventional radar had antennas arranged in the radar in the vertical direction, the performance in the direction perpendicular to the road, that is, in the direction of elevation angle (β), was inevitably poor. As illustratively shown in FIG. 2 as radiation pattern, detection of mid/long-distance objects located over a certain distance was possible to some extent, but there occurred problems that detection of short-distance object is limited or even impossible and that it is difficult to grasp the traffic conditions on roads with steep slopes.

To solve these problems, it may consider mounting a radar responsible for detection in the horizontal direction and a radar having an installation direction different therefrom and responsible for detection in the direction of elevation angle on an autonomous vehicle in the same direction and separately. However, the radar is a very expensive component and is large in volume, which causes an increase in the overall vehicle price and is practically impossible because it is difficult to secure the installation area.

In light of the above problems, the present invention relates to a radar module of new and advanced technology that can minimize the number of installations and prevent an increase in the price of autonomous vehicles by improving the detection performance in the horizontal direction as well as the detection performance in the direction of elevation angle through a single radar.

The technical task to be solved by the present invention is to provide a wide FoV radar module for three-dimensional detection that can minimize the number of installations by improving the detection performance in the horizontal direction as well as the detection performance in the direction of elevation angle through a single radar.

Another technical task to be solved by the present invention is to provide a wide FoV radar module for three-dimensional detection that can accurately detect short-distance objects as well as roads with steep slopes by improving the detection performance of the radar module in the direction of elevation angle.

The technical tasks of the present invention are not limited to those mentioned above, and other technical tasks not mentioned will be clearly understood by those skilled in the art from the description below.

### SUMMARY

A wide FoV radar module for three-dimensional detection according to an embodiment of the present invention for achieving the above technical tasks comprises a plurality of transmission channel units (Tx) including A (A is a natural number of two or more) number of transmission channel antennas and being each connected to a radar chip; a plurality of reception channel units (Rx) including B (B is a natural number of two or more) number of reception channel antennas and being each connected to the radar chip; and a power supply unit for supplying power to the transmission channel units, the reception channel units and the radar chip, wherein one or more of the plurality of transmission channel units includes C (C is a natural number greater than or equal to 0 and less than or equal to A) number of 1-1st transmission channel antennas arranged in a first direction; and D (D is a natural number greater than or equal to 0 and less than or equal to A, C+D=A) number of 1-2nd transmission channel antennas arranged in a second direction different from the first direction.

According to an embodiment, the second direction may be a direction rotated by 90° clockwise or counterclockwise from the first direction.

According to an embodiment, the number of radiating elements included in the 1-1st transmission channel antenna and the number of radiating elements included in the 1-2nd transmission channel antenna may be different from each other.

According to an embodiment, the number of radiating elements included in the 1-1st transmission channel antenna may exceed the number of radiating elements included in the 1-2nd transmission channel antenna.

According to an embodiment, the number of radiating elements included in the 1-1st transmission channel antenna may be twice the number of radiating elements included in the 1-2nd transmission channel antenna.

According to an embodiment, if the number of the 1-1st transmission channel antenna is plural, each of the two or more 1-1st transmission channel antennas may be arranged with a step of a predetermined length in the first direction.

According to an embodiment, the reception channel unit may include one or more 1-1st reception channel antennas arranged in the first direction and one or more 1-2nd reception channel antennas arranged in a second direction different from the first direction.

According to an embodiment, the number of radiating elements included in the 1-1st reception channel antenna and the number of radiating elements included in the 1-2nd reception channel antenna may be different from each other.

According to an embodiment, A which is the number of transmission channel antenna may be less than B which is the number of reception channel antenna.

According to an embodiment, the 1-1st transmission channel antenna may have a symmetrical shape with respect to the second direction, and the 1-2nd transmission channel antenna has a symmetrical shape with respect to the first direction.

According to the present invention, at least one of the plurality of transmission channel units includes a 1-1st transmission channel antenna arranged in the first direction, thereby being responsible for detecting the short/mid/long distance horizontal directions and the detection of the mid/long distance elevation angle directions, By including a 1-2nd transmission channel antenna arranged in a second direction different from the first direction, it is responsible for detection of the short-distance horizontal direction and detection of the short-distance elevation angle direction, and detects the horizontal direction compared to the prior art through a single radar module. In addition to performance, the detection performance in the elevation angle direction is improved, which has the effect of minimizing the number of mounting units.

In addition, there is an effect that detection performance in the elevation angle direction can be further improved by arranging the 1-1st transmission channel antenna arranged in the first direction with a step of a predetermined length in the first direction.

In addition, the reduction in the beam width in the horizontal direction is minimized by reducing the number of radiating elements of the 1-2nd transmission channel antenna arranged in the second direction compared to the number of radiating elements of the 1-1st transmission channel antenna arranged in the first direction. By maximizing the azimuth angle in the direction and improving the detectable area in the elevation angle direction, there is the effect of enabling accurate detection even of close objects or roads with a steep slope.

The effects of the present invention are not limited to the effects mentioned above, and other effects not mentioned will be clearly understood by those skilled in the art from the description below.

### BRIEF DESCRIPTION OF THE DRAWINGS

FIG. 1 is a diagram illustrating a conventional autonomous vehicle and a radar module mounted thereon in which detecting the horizontal direction is shown.

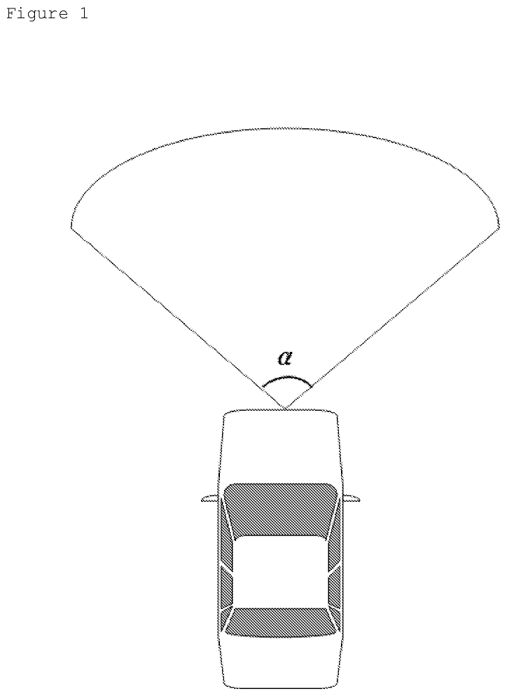

FIG. 2 is a diagram illustrating an example of a conventional autonomous vehicle and a radar module mounted thereon in which detecting an elevation angle direction is shown.

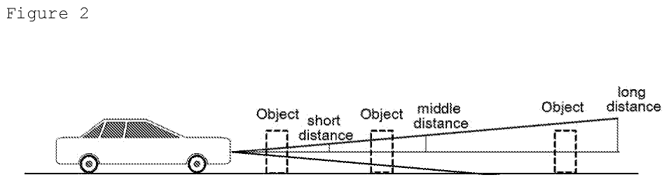

FIG. 3 is a diagram showing the configuration of a wide FoV radar module for three-dimensional detection according to an embodiment of the present invention.

FIG. 4 is a diagram illustrating a plurality of transmission channel units.

FIG. 5 is a diagram illustrating a plurality of reception channel units.

FIG. 6 is a diagram illustrating the transmission channel unit and the reception channel unit shown in FIGS. 4 and 5 in one drawing, together with a radar chip.

FIG. 7 is a diagram illustrating an area in the horizontal and elevation angle directions detected by the 1-1 transmission channel antenna.

FIG. 8 is a diagram illustrating an area in the horizontal and elevation angle directions detected by the 1-2 transmission channel antenna.

FIG. 9 is a diagram illustrating a horizontal radiation pattern when the number of radiating elements is eight and a horizontal radiation pattern when the number of radiating elements is four.

FIG. 10 is a diagram illustrating channel characteristics of a wide FoV radar module for three-dimensional detection according to an embodiment of the present invention.

FIG. 11 is a diagram illustrating the arrangement of the 1-2nd reception channel antenna in the second direction with a step of a predetermined length.

FIG. 12 is a diagram illustrating the arrangement of of a the 1-2nd transmission channel antenna with a step predetermined length in the second direction.

Hereinafter, the preferred embodiments of the present invention will be described in detail with reference to the accompanying drawings. Advantages and features of the present invention and methods of achieving them will be apparent with reference to the embodiments described below in detail together with the accompanying drawings. However, the present invention is not limited to the embodiments disclosed below, and may be implemented in various forms different from each other, and these embodiments are provided only to make the disclosure of the present invention complete and to completely inform the scope of the present invention to those skilled in the art, and the present invention is defined only by the scope of the claims. Throughout the specification, like reference numerals refer to like components.

Unless otherwise defined, all terms (including technical and scientific terms) used in the present specification may be used in a meaning that can be commonly understood by those skilled in the art. In addition, the terms defined in a generally used dictionary are not ideally or excessively interpreted unless explicitly and specially defined. The terms used in the present specification are for describing the embodiments and not intended to limit the present invention. In the present specification, singular forms also include plural forms unless otherwise specified in the phrase.

The term “comprises” and/or “comprising” used in the present specification does not exclude presence or addition of one or more other components, steps, operations and/or elements than the mentioned components, steps, operations and/or element.

### DETAILED DESCRIPTION OF THE INVENTION

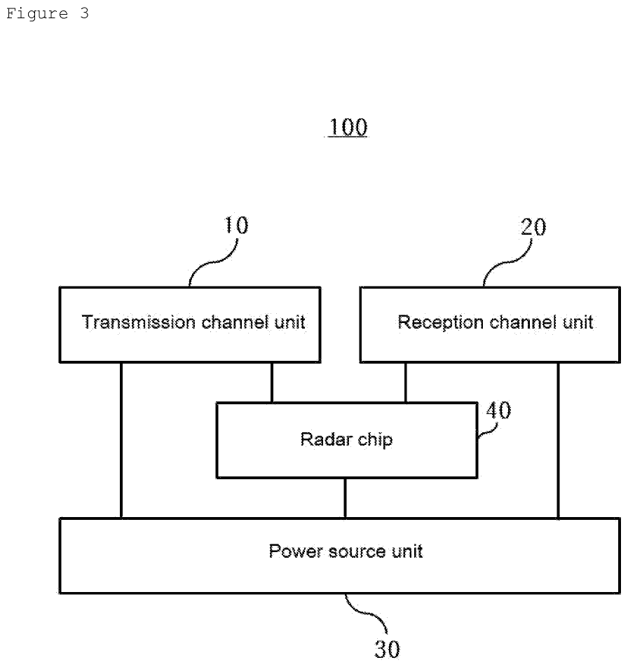

FIG. 3 is a diagram showing the configuration of a wide FoV radar module 100 for three-dimensional detection according to an embodiment of the present invention.

The wide FoV radar module 100 for three-dimensional detection according to an embodiment of the present invention includes a transmission channel unit 10, a reception channel unit 20 and a power source unit 30. The wide FoV radar module 100 may further include typical configurations required for achieving the purpose of the present invention, for example, one or more radar chips 40 which is connected to the transmission channel unit 10, the reception channel unit 20 and the power source unit 30 for performing the role of a control unit which is a type of processor.

The plurality of transmission channel units (Tx) 10 transmit electromagnetic waves, include A (A is a natural number of two or more) number of transmission channel antennas 11 and are each connected to the radar chip 40.

Here, since A is a natural number of two or more, the number of transmission channel antennas 11 included in the transmission channel unit 10 is plural, and one transmission channel unit 10 including a plurality of transmission channel antennas 11 can be connected to one radar chip 40.

Accordingly, the connection between the transmission channel unit 10 and the radar chip 40 can be seen as a 1:1 relationship, but since one transmission channel unit 10 includes a plurality of transmission channel antennas 11, the connection between the transmission channel antenna 11 and the radar chip 40 can be seen as an A:1 relationship.

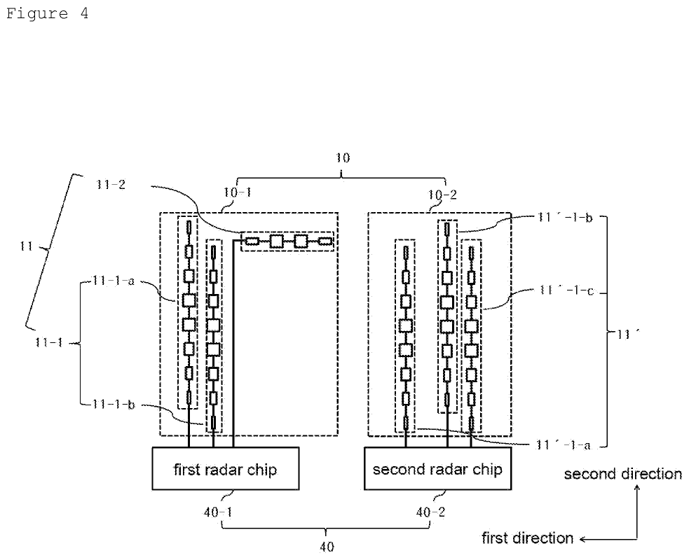

FIG. 4 is a diagram illustrating a plurality of transmission channel units 10. Each of the plurality of transmission channel antennas 11 included in one transmission channel unit 10 becomes one transmission channel. Referring to FIG. 4, the transmission channel unit 10-1 arranged on the left includes three transmission channel antennas 11-1, and another transmission channel unit 10-2 arranged on the right includes three transmission channels 11-2. Thus, it has the structure of a total of six transmission channels.

Additionally, referring to FIG. 4, the first radar chip 40-1 arranged on the left of the two radar chips 40 is connected to one transmission channel unit 10-1 and the second radar chip 40-2 arranged on the right is connected to another transmission channel unit 10-2, thereby connecting in a 1:1 relationship, and each transmission channel unit 10-1 and 10-2 includes three transmission channel antennas and thus the transmission channel antenna 11 and the radar chip 40 are connected in a 3:1 relationship.

Meanwhile, referring again to FIG. 4, it can be seen that both the transmission channel units 10-1 and 10-2 are arranged with a step of a predetermined length in the vertical direction in arranging the transmission channel antenna 11 which each of them includes (that is, 11-1-a, 11-1-b, 11′-1-a, 11′-1-b, 11′-1-c). This corresponds to the technical features of the wide FoV radar module 100 for three-dimensional detection according to an embodiment of the invention for improving the detection performance in the direction of elevation angle. The transmission channel unit 10-1 arranged on the left includes a transmission channel antenna 11-1-a arranged in the vertical direction and a transmission channel antenna 11-12 arranged in a horizontal direction, and the number of radiating elements included in each of the transmission channel antennas 11-1-a and 11-1-b arranged in the vertical direction and a transmission channel antenna 11-12 arranged in a horizontal direction is different each other. This also corresponds to the core technical features of the radar module 100 according to one embodiment of the present invention for improving the detection performance in the direction of elevation angle, and will be explained in detail after the explanation regarding the power supply unit 30.

A plurality of reception channel units (Rx) 20 receive echo waves reflected back when electromagnetic waves transmitted by the transmission channel unit 10 collide with an object, include B (B is a natural number of two or more) number of reception channel antennas 21 and are each connected to the radar chip 40.

Here, since B is a natural number of two or more, the number of reception channel antennas 21 included in the reception channel unit 20 is plural, and one reception channel unit 20 including a plurality of reception channel antennas 21 can be connected to one radar chip 40.

Accordingly, the connection between the reception channel unit 20 and the radar chip 40 can be seen as a 1:1 relationship, but since one reception channel unit 20 includes a plurality of reception channel antennas 21, the connection between the reception channel antenna 21 and the radar chip 40 can be seen as a B:1 relationship.

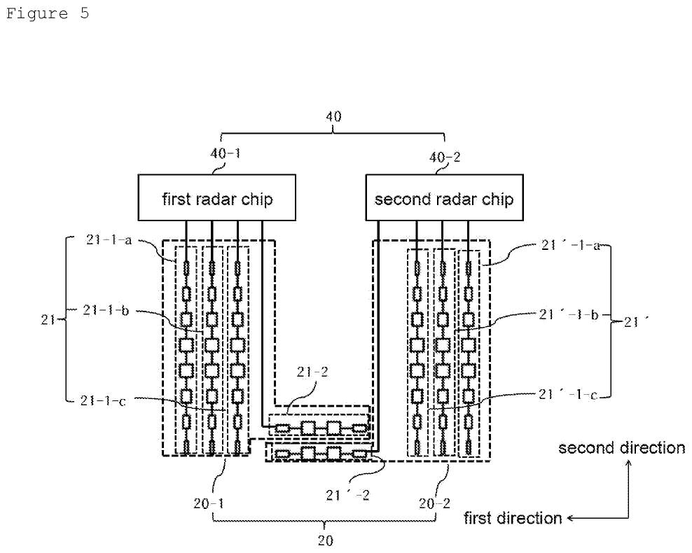

FIG. 5 is a diagram illustrating a plurality of reception channel units 20 in which each of the plurality of reception channel antennas 21 included in one reception channel. unit 20 becomes one reception channel. Referring to FIG. 5, the reception channel unit 20-1 arranged on the left includes four reception channel antennas 21-1, and another reception channel unit 20-2 arranged on the right includes four reception channel antennas 21-2. Therefore, it has a structure of a total of 8 reception channels.

Additionally, referring to FIG. 5, the radar chip 40-1 arranged on the left of two radar chips 40 is connected to one reception channel unit 20-1 and the radar chip 40-2 arranged on the right is connected to another reception channel unit 20-2, thereby being connected in a 1:1 relationship. Each reception channel unit 20-1 and 20-2 includes four transmitting channel antennas 11 and therefore, the reception channel antenna 21 and the radar chip 40 are connected in a 4:1 relationship.

Meanwhile, referring again to FIG. 5, it can be seen that in the arrangement of the reception channel antennas 21 included in each of the reception channel units 20-1 and 20-2, some are arranged in the vertical direction (21-1-a, 21-1-b, 21-1-c, 21′-1-a, 21′-1-b, some are arranged in the horizontal direction (21-2, 21′-2), and the number of radiating elements included in reception channel antennas 21-1-a, 21-1-b,21-1-c, 21′-1-a, 21′-1-b, and 21′-1-c arranged in the vertical direction and the number of radiating elements included in reception channel antennas 21-2 and 21′-2 arranged in the horizontal direction are different from each other. This also corresponds to the core technical features of the wide FoV radar module 100 for three-dimensional detection according to an embodiment of the present invention for improving the detection performance in the direction of elevation angle, as in the case for the transmission channel unit 10, which will be explained after the explanation of the power supply unit 30.

The power source unit 30 supplies power to the transmission channel unit 10, the reception channel unit 20 and the radar chip 40. The power signal supplied to the power source unit 30 can effectively supply the power to the transmission channel unit 10, the reception channel unit 20 and the radar chip 40 by receiving the power from a battery (not shown) mounted on an autonomous vehicle (not shown) and repeating charging and discharging. If the wide FoV radar module 100 for three-dimensional detection according to an embodiment of the present invention does not operate depending on the driving state of the autonomous vehicle (not shown) (for example, if the autonomous vehicle goes backwards in the state that the wide FoV radar module 100 for three-dimensional detection according to an embodiment of the present invention has been mounted in the front of the autonomous vehicle, etc.), the radar module 100 operates in sleep mode to thereby prevent unnecessary power consumption.

So far, the configurations of the wide FOV radar module 100 for three-dimensional detection according to an embodiment of the present invention have been described. Hereinafter, key technical features of the wide FoV radar module 100 for three-dimensional detection according to an embodiment of the present invention for improving detection performance in the elevation angle direction and horizontal direction, for which description was reserved previously, will be described.

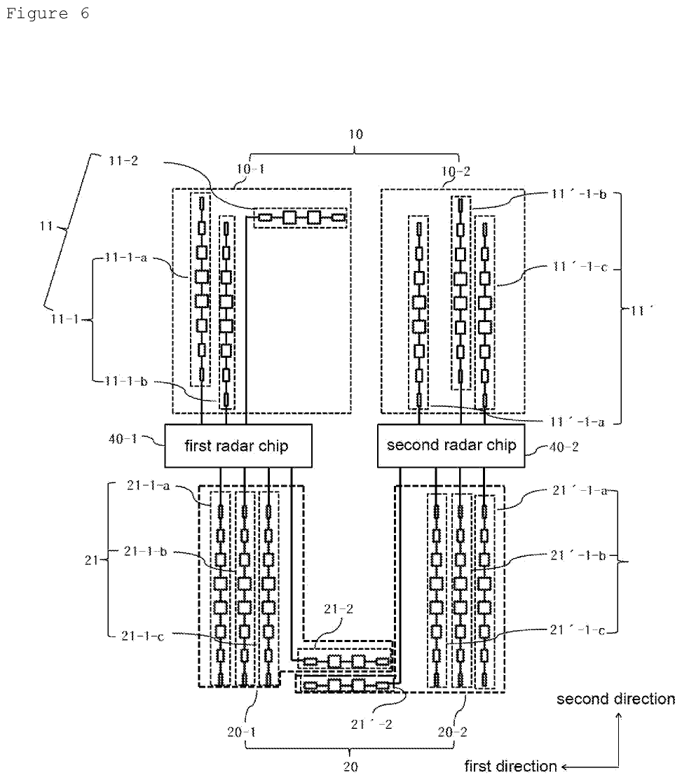

FIG. 6 is a diagram illustrating the wide FoV radar module 100 for three-dimensional detection according to an embodiment of the present invention in which FIGS. 4 and 5 are shown together. The transmission channel unit arranged on the left among the transmission channel units 10 shown in FIG. 6 is named as a first transmission channel part 10-1 for convenience, and the transmission channel unit arranged on the right is named as a second transmission channel unit 10-2. The radar chip arranged on the left is named as a first radar chip (40-1), and the radar chip arranged on the right is named as a second radar chip 40-2. The reception channel arranged on the left is named as a first reception channel unit 20-1, and the reception channel arranged on the right is named as a second reception channel unit 20-2.

The description applied to the first transmission channel unit 10-1 in relation to the transmission channel unit 10 can be equally applied to the second transmission channel unit 10-2, and thus the explanation will be made based on the first transmission channel unit 10-1.

The first transmission channel unit 10-1 may include C (C is a natural number greater than or equal to 0 and less than or equal to A) number of the 1-1st transmission channel antennas 11-1 arranged in a first direction and the 1-2nd transmission channel antennas 11-2 arranged in a direction D (D is a natural number greater than or equal to 0 and less than or equal to A, C+D=A) arranged in a second direction different from the first direction. Applying this to the first transmission channel unit 10-1, 11-1-a and 11-1-b (transmission channel antennas arranged in the vertical direction) and 11-2 (transmission channel antennas arranged in the horizontal direction) mentioned in the previous description become the 1-1st transmission channel antenna 11-1 and the 1-2nd transmission channel antenna 11-2, respectively.

Meanwhile, the number of the 1-1st transmission channel antennas 11-1 is sufficient to be 0 or more and A or less, and the number of the 1-2nd transmission channel antennas 11-2 is also sufficient to be 0 or more and A or less, and thus the form of the transmission channel unit 10-1 can be divided into cases of i) including only the 1-1st transmission channel antenna 11-1 arranged in the first direction, ii) including only the 1-2nd transmission channel antenna 11-2 arranged in the second direction and iii) including both of a portion of the 1-1st transmission channel antenna 11-1 arranged in the first direction and the 1-2nd transmission channel antenna 11-2 arranged in the second direction. In case of i), one or more transmission channel units among the plurality of transmission channel units 10 indicate the form of i) and thus one or more transmission channel units among the remaining transmission channel units should indicate the forms of ii) and iii). In the case of ii), one or more transmission channel units among the plurality of transmission channel units 10 indicate the form of ii) and thus one or more transmission channel units among the remaining transmission channel units must indicate the form of i) or iii). In the case of iii), at least one of the plurality of transmission channel units 10 indicates the form of iii) and thus at least one of the remaining transmission channel units should indicate the form of i), ii) or iii) thereby seeking improvement of the elevation angle performance that the present invention aims to achieve. That is, in any case, it should include the 1-2nd transmission channel antenna 11-2 arranged in the second direction.

The present explanation is made based on the case of iii), but the explanation can be equally applied to i) and ii). Referring to FIG. 6 related to the case of iii), it can be seen that the first direction which is the direction in which two of the 1-1st transmission channel antennas 11-1 are arranged is the vertical direction, and the second direction which is the direction in which one of the 1-2nd transmission channel antennas 11-2 is arranged is the horizontal direction. Accordingly, the second direction may be a direction rotated clockwise or counterclockwise from the first direction by a predetermined angle, greater than 0° or less than 180° depending on the characteristics of the antenna. As the predetermined angle, 90° is exemplarily shown in FIG. 6.

The transmission channel of a typical radar module has generally all of the plurality of transmission channel antennas arranged in the same direction, whilst a wide FOV radar module for three-dimensional detection according to an embodiment of the present invention (100) makes the arrangement direction of some of the transmission channel antennas 11 included in the transmission channel unit 10 different from the arrangement direction of the others to thereby seek improvement of detection performance in the elevation angle direction.

More specifically, among the 1-1st transmission channel antennas 11-1 shown in FIG. 6, the two 1-1st transmission channel antennas 11-1-a and 11-1-b are responsible for detecting the mid/long-distance elevation angle direction, and the 1-2nd transmission channel antenna 11-2 arranged by rotating 90° from these is responsible for detecting the short-distance elevation angle direction.

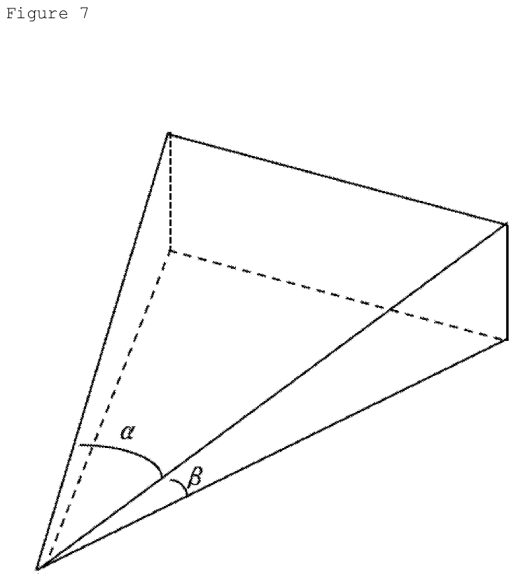

This utilizes the three-dimensional characteristic of turning into an elevation angel direction when rotated 90° from the horizontal direction. Referring to FIG. 7, it can be seen that the areas in the horizontal and elevation angle directions detected by either the 1-1st transmission channel antenna 11-1-a or 11-1-b are shown as an example and that the azimuth angle (α) is significantly wider than the elevation angle (β).

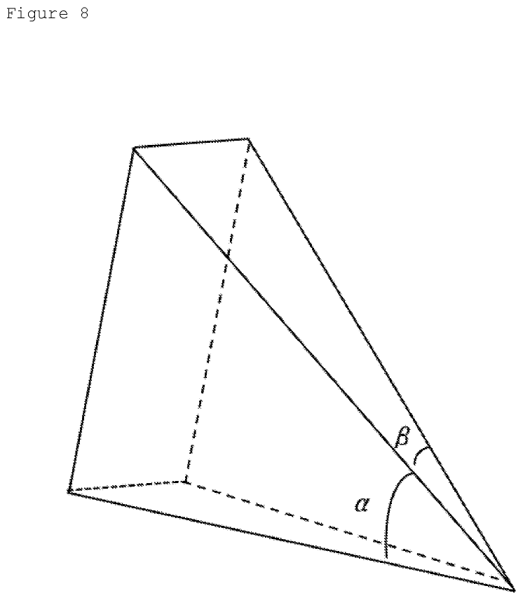

However, according to the wide FoV radar module 100 for three-dimensional sensing according to an embodiment of the present invention, any one or more of the plurality of 1-1st transmission channel antennas 11-1, 11-2 in FIG. 6, is arranged by rotation of 11-2 by 90° with respect to 11-1-a and 11-1-b, and thus the area detected by 11-2 becomes as shown in FIG. 8. That is, the azimuth angle (α), which was wide in FIG. 7, becomes an elevation angle in FIG. 8 and the elevation angle (β), which was narrow, becomes an azimuth angle, and thus the detection performance in the elevation angle direction of a short-range object can be significantly improved.

This improvement of the detection performance in the elevation angle direction, that is, precise three-dimensional detection, will increase as the number of transmission channel units 10 increases, that is, as the number of radar chips 40 increases, and the radar module should receive the echo wave returned back after hitting the object and thus the existence of a reception channel unit 20 with an antenna arranged in the same/similar manner as the transmission channel unit 10 is essential. Accordingly, the reception channel unit 20 may include one or more 1-1st reception channel antennas 21-1 arranged in a first direction and one or more 1-2nd reception channel antennas 21-2 arranged in a second direction different from the first direction. It is okay for the number of channels of the transmission channel unit 10 and the reception channel unit 20 to be different and thus it is okay for the number of specific reception channel antennas to be different.

Now, the number of radiating elements included in the 1-1st transmission channel antenna 11-1 and the 1-2nd transmission channel antenna 11-2 will be explained.

Referring again to FIG. 6, it can be seen that the number of radiating elements of 11-1-a and 11-1-b which are 1-1st transmission channel antennas 11-1 included in the first transmission channel unit 10-1 and arranged in the first direction is different from the number of radiating elements of the 1-2nd transmission channel antenna 11-2 arranged in the second direction. More specifically, it can be seen that the number of radiating elements of the transmission channel antennas 11-1-a and 11-1-b which are 1-1st transmission channel antennas arranged in the first direction is eight, whilst the number and radiating elements of the 1-2nd transmission channel antenna 11-2 arranged in the second direction are four, and thus the number of radiating elements included in the 1-1st transmission channel antenna 11-1 exceeds the number of radiating elements included in the 1-2nd transmission channel antenna 11-2 (in the case of FIG. 6, it is twice).

In constructing an antenna, if the number of radiating elements is reduced, the gain of the antenna is reduced and thus the detectable distance is shortened. However, in the wide FoV radar module 100 for three-dimensional detection according to an embodiment of the present invention, 11-1-a and 11-1-b which are one or more 1-1st transmission channel antennas 11-1 arranged in the first direction have a wide azimuth angle (wide angle) in the horizontal direction and can responsible for detecting the elevation angle direction of objects located at mid/long distances. The number of radiating elements of the one or more 1-2nd transmission channel antennas 11-2 arranged in the second direction is smaller than that of the 1-1st transmission channel antenna 11-1, and thus only the object located at a short distance is detectable. However, the azimuth angle of 11-1-a and 11-1-bwhich are the 1-1st transmission channel antennas 11-1 arranged in the first direction becomes the elevation angle of the 1-2nd transmission channel antenna 11-2 arranged in the second direction and thus even if the gain is reduced, it directly contributes to improvement of detection performance in the elevation angle direction and can be used without any problem.

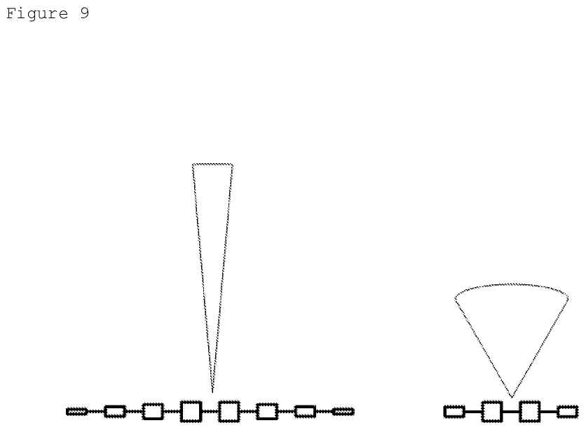

Meanwhile, with regard to detection of the horizontal direction, 11-1-a and 11-1-b which are one or more 1-1st transmission channel antennas 11-1 arranged in the first direction have a wide azimuth angle in the horizontal direction and the number of radiating elements of the one or more 1-2nd transmission channel antennas 11-2 arranged in the second direction can be reduced. Therefore, the reduction in the beam width in the horizontal direction is minimized and the azimuth angle in the horizontal direction is secured to the maximum, thereby expanding the azimuth angle to a detectable area in the elevation angle direction which can be easily confirmed by referring to FIG. 9, which exemplarily shows the horizontal radiation pattern when the number of radiating elements is eight and the horizontal radiation pattern when the number of radiating elements is four. These matters can be equally applied to the 1-1st reception channel antenna 21-1 and the 1-2nd reception channel antenna 21-2.

Separately from the above, looking at the shape of the transmission channel antenna 11 according to the arrangement of the radiating elements, 11-1-a and 11-1-b which are the 1-1st transmission channel antennas 11-1 are arranged in the first direction and thus it has a symmetrical shape with respect to the second direction, and the 1-2nd transmission channel antenna 11-2 is arranged in the second direction and thus it has a symmetrical shape with respect to the first direction. It is known that the antenna used in the radar module is an array-type antenna of symmetrical shape, and in the case of the wide FoV radar module for three-dimensional detection according to an embodiment of the present invention, the 1-1st transmission channel antenna 11-1 is arranged in the first direction, and the 1-2nd transmission channel antenna 11-2 is arranged in the second direction and thus, the standard of symmetry for them is the second direction and the first direction, respectively which is different from each other. This can be applied to the 1-1st reception channel antenna 21-1 and the 1-2nd reception channel antenna 21-2.

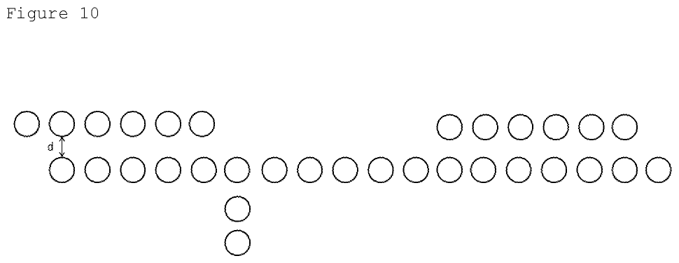

Through the above-described details, the wide FoV radar module 100 for three-dimensional detection according to an embodiment of the present invention can improve the performance in the short-distance elevation angle direction which was a problem in the prior art and at the same time can implement the performance in the short/middle/long-distance horizontal directions by the wide FoV. In addition, when the number of the 1-1st transmission channel antennas 11-1 is plural, each of two or more 1-1st transmission channel antennas of them is arranged with a step of a predetermined length in the first direction thereby further improving the performance in the elevation angle direction. Referring to FIG. 10 showing the channel characteristics of the wide FoV radar module 100 for three-dimensional detection according to an embodiment of the present invention shown in FIG. 6, it can be seen that when the length of the step is d, the channel characteristics in the elevation angle direction are also improved by d.

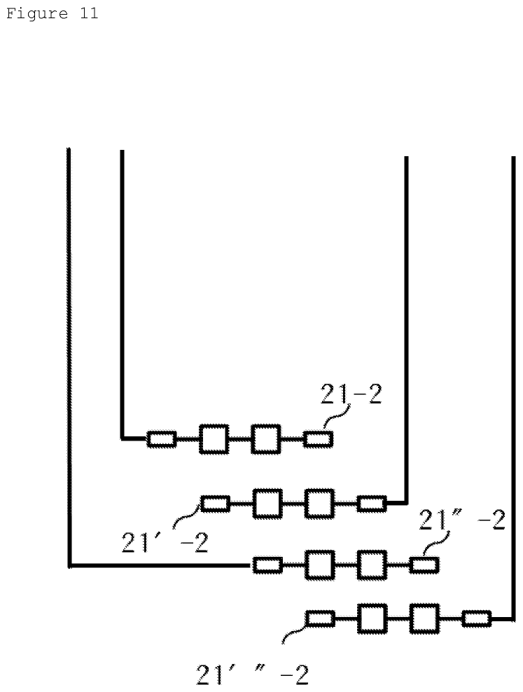

Meanwhile, with regard to the step, in case that the number of radar chip 40 including not only the 1-1st transmission channel antenna 11-1 described above but also the 1-2nd reception channel antenna 21-2 arranged in the second direction is plural, a step of a predetermined length is formed in the 1-2nd reception channel antennas 21-2 and 21′-2 included in the receiving channel 20 connected to different radar chips 40 by adjusting the arrangement position between the radar chips 40, thereby dramatically improving the performance in the horizontal direction while improving the performance in the elevation angle direction, which is illustratively shown in FIG. 11.

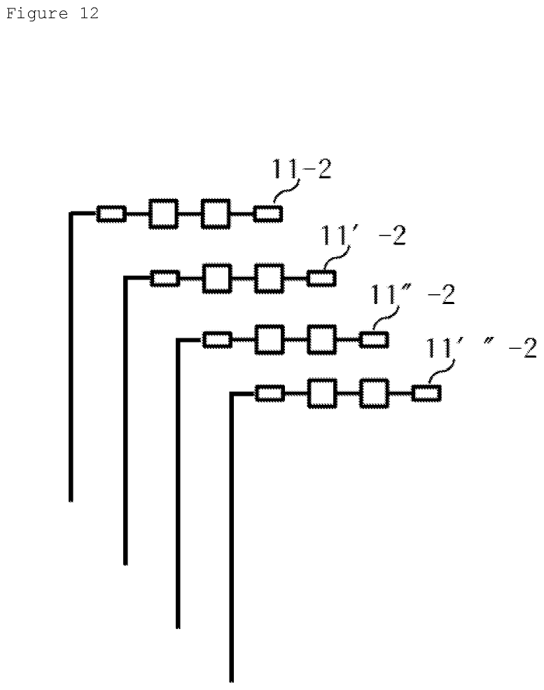

Likewise, in case that the number of radar chip 40 including the 1-2 transmission channel antenna 11-2 arranged in the second direction is plural, the 1-2nd reception channel antenna 11-2 included in the transmission channel 10 connected to different radar chips 40 is arranged in the first direction together with the 1-2nd reception channel antennas 21-2 and 21′-2 to form an upper/lower relationship in which a step of a predetermined length is formed in the second direction, thereby dramatically improving the performance in the horizontal direction while improving the performance in the elevation angle direction, which is illustratively shown in FIG. 12.

So far, the wide FoV radar module 100 for three-dimensional detection according to an embodiment of the present invention has been described. According to the present invention, at least one of the plurality of transmission channel units 10 includes a 1-1st transmission channel antenna 11-1 arranged in the first direction, thereby being responsible for detecting the short/mid/long distance horizontal directions as well as mid/long distance directions. Therefore, compared to the prior art, the number of mounting units can be minimized by improving the detection performance in the horizontal direction as well as the detection performance in the elevation angle direction through a single radar module. Also, the detection performance in the elevation angle direction can be further improved by arranging the 1-1st transmission channel antenna 11-1, which has been arranged in the first direction, with a step of a predetermined length in the first direction. Furthermore, by reducing the number of radiating elements of the 1-2 transmission channel antenna 11-2 arranged in the second direction compared to the number of radiating elements of the 1-1st transmission channel antenna 11-1 arranged in the first direction, the decrease of beam width in horizontal direction can be minimized and the azimuth angle in the horizontal direction is secured to the maximum, thereby expanding the detectable area in the elevation angle direction and enabling accurate detection in short-distance objects or on roads with steep slopes.

Meanwhile, although all of the above descriptions have been made based on an embodiment in which there are two radar chips 40, that is, one transmission channel unit 10 and one reception channel unit 20 are connected to each radar chip 40, this is only exemplary and as the number of radar chips 40 increases, the number of channels also increases (a common radar module uses four radar chips, with transmission three channels/reception four channels, A is less than B) and thus, it is possible to implement a radar module enabling more precise detection in horizontal and elevation angle directions through various combinations such as a combination of the 1-1st transmission channel antenna (11-1) and the 1-2nd transmission channel antenna (11-2) and a combination of the 1-1st reception channel antenna (21-1) and the 1-2nd reception channel antenna (21-2). Because radar modules mounted on autonomous vehicles have basically high requirement for expansion of the azimuth angle which is the detection performance in the horizontal direction, the present invention can be used for efficient arrangement to secure sufficient channels in the horizontal direction and secure the performance in the short-distance elevation angle direction.

Although the embodiments of the present specification have been described with reference to the accompanying drawings, those skilled in the art may understand that the present invention may implemented in other specific forms without changing the technical spirit or essential features. Therefore, it should be understood that the embodiments described above are illustrative and not restrictive in all respects.

1. A wide FoV radar module for three-dimensional detection comprising:
a plurality of transmission channel units (Tx) including A (A is a natural number of two or more) number of transmission channel antennas and being each connected to a radar chip;
a plurality of reception channel units (Rx) including B (B is a natural number of two or more) number of reception channel antennas and being each connected to the radar chip; and
a power supply unit for supplying power to the transmission channel units, the reception channel units and the radar chip,
wherein one or more of the plurality of transmission channel units includes:
C (C is a natural number greater than or equal to 0 and less than or equal to A) number of 1-1st transmission channel antennas arranged in a first direction; and
D (D is a natural number greater than or equal to 0 and less than or equal to A, C+D=A) number of 1-2nd transmission channel antennas arranged in a second direction different from the first direction.

2. The wide FOV radar module according to claim 1, wherein the second direction is a direction rotated by 90° clockwise or counterclockwise from the first direction.

3. The wide FoV radar module according to claim 1, wherein the number of radiating elements included in the 1-1st transmission channel antenna and the number of radiating elements included in the 1-2nd transmission channel antenna are different from each other.

4. The wide FoV radar module according to claim 3, wherein the number of radiating elements included in the 1-1st transmission channel antenna exceeds the number of radiating elements included in the 1-2nd transmission channel antenna.

5. The wide FoV radar module according to claim 3, wherein the number of radiating elements included in the 1-1st transmission channel antenna is twice the number of radiating elements included in the 1-2nd transmission channel antenna.

6. The wide FOV radar module according to claim 1, wherein if the number of the 1-1st transmission channel antenna is plural, each of the two or more 1-1st transmission channel antennas is arranged with a step of a predetermined length in the first direction.

7. The wide FoV radar module according to claim 1, wherein the reception channel unit includes:
one or more 1-1st reception channel antennas arranged in the first direction; and
one or more 1-2nd reception channel antennas arranged in a second direction different from the first direction.

3. The wide FOV radar module according to claim 1, wherein the number of radiating elements included in the 1-1st reception channel antenna and the number of radiating elements included in the 1-2nd reception channel antenna are different from each other.

9. The wide FOV radar module according to claim 1, wherein A, which is the number of transmission channel antenna, is less than B which is the number of reception channel antenna.

10. The wide FOV radar module according to claim 1, wherein the 1-1st transmission channel antenna has a symmetrical shape with respect to the second direction, and the 1-2nd transmission channel antenna has a symmetrical shape with respect to the first direction.
